(19) United States
(12) Patent Application Publication
(10) Pub. No.: US 2023/0177077 A1
(43) Pub. Date: Jun. 8, 2023

(54) ENHANCING INPUT TO CONVERSATIONAL AGENTS THROUGH FEEDBACK

(71) Applicant: INTERNATIONAL BUSINESS MACHINES CORPORATION, ARMONK, NY (US)

(72) Inventors: Jason Andrew Telner, Lackawanna, NY (US); Jon Gerard Temple, Southbury, CT (US); Tyler Waite, Lake Washington, WA (US); Donna Thelander, Kailua Kona, HI (US); Mark Willard Malatesta, Ortonville, MI (US); William G. Dusch, Morrisville, NC (US)

(21) Appl. No.: 17/643,204

(22) Filed: Dec. 8, 2021

(51) Int. Cl. G06F 16/33; G06F 16/338; G06F 16/36; G10L 15/30; G10L 15/22; G10L 15/18; G06F 40/30; G06F 40/289; G06F 40/166; G06F 40/247

(52) U.S. Cl. CPC G06F 16/3344; G06F 16/338; G06F 16/374; G10L 15/30; G10L 15/22; G10L 15/1815; G06F 40/30; G06F 40/289; G06F 40/166; G06F 40/247

(57) ABSTRACT

A computer-implemented method, a computer system and a computer program product enhance user input to a conversational agent. The method includes identifying a word using a natural language processing algorithm. The word is in a query from a user to the conversational agent. The method also includes determining a set of keywords related to each of a plurality of intents associated with the conversational agent within a database. In addition, the method includes calculating a semantic similarity score between each determined set of keywords and the identified word. Lastly, the method includes displaying the identified word on a screen to the user when the identified word is not found in each determined set of keywords and when the semantic similarity score is above a threshold. The display includes a distinct indication of the identified word.

### BACKGROUND

Embodiments relate generally to the field of natural language processing, and in particular to improving user input to automated conversational agents through feedback from the agent.

Chatbots, talkbots, instant messaging bots, artificial conversational entities, and the like, (“chatbots”) are software applications designed to simulate natural language communication, conversation, and dialogue with humans and end-users. To facilitate these interactions, the chatbot may need to understand, interpret, and determine an expressed intent of an end-user and may generate desired outputs by correctly determining expressed intents of end-users.

The chatbot may determine an expressed intent by implementing a natural language classifier to disambiguate, understand, and interpret the expressed intent, where the expressed intent may include, for example, free-form text and/or utterances. An end-user interacting with a chatbot may ask a question that may be displayed on a computer screen and, once the chatbot understands the intent of the question, an answer to the question may be displayed on the screen.

### SUMMARY

An embodiment is directed to enhancing user input to a conversational agent. The method may include identifying a word using a natural language processing algorithm. The word may be in a query from a user to the conversational agent. The method also includes determining a set of keywords related to each of a plurality of intents associated with the conversational agent within a database. The method further includes calculating a semantic similarity score between each determined set of keywords and the identified word. Lastly, the method includes displaying the identified word on a screen to the user when the identified word is not found in each determined set of keywords and when the semantic similarity score is above a threshold. The display may include a distinct indication of the identified word.

In an embodiment, the method may include displaying to the user a list of keywords from the determined set of keywords corresponding to an intent with a highest semantic similarity score in response to an indication from the user. In this embodiment, the method may also include replacing the identified word on the screen with the selected keyword in response to the user selecting a keyword from the displayed list.

In another embodiment, identifying the word may include determining a meaning of the word with the natural language processing algorithm. In this embodiment, identifying the word may also include generating a synonym. The synonym may have a meaning that matches the meaning of the word. In this embodiment, identifying the word may further include calculating a new semantic similarity score between each determined set of keywords and the synonym. Lastly, in this embodiment, identifying the word may include displaying the identified word on the screen to the user when the synonym is not found in each determined set of keywords and when the semantic similarity score is above the threshold, where the display may include the distinct indication of the identified word.

In a further embodiment, the method may include receiving a second word from the user, where the second word may be included in the query and may be entered at a time subsequent to the identified word. The method may also include combining the second word and the identified word into a phrase and identifying the phrase using the natural language processing algorithm. The method may further include generating a combined semantic similarity score between each determined set of keywords and the phrase. Lastly, the method may include displaying the phrase on the screen to the user when the phrase is not found in each determined set of keywords and when the combined semantic similarity score is above the threshold. The display may include the distinct indication of the identified word.

In yet another embodiment, determining the set of keywords may include calculating a word embedding for each keyword in the set of keywords. In this embodiment, determining the set of keywords may also include combining the calculated word embeddings for each keyword in the set of keywords into an overall embedding for the set. In this embodiment, determining the set of keywords may also include storing the overall embedding for the set with the set of keywords in the database.

In an embodiment, the method may include capturing a spoken query from the user using a microphone and generating the word using a speech-to-text algorithm.

In another embodiment, the distinct indication of the identified word may include a distinct typeface or a distinct font.

In addition to a computer-implemented method, additional embodiments are directed to a system and a computer program product for enhancing user input to a conversational agent.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a block diagram of an example computer system in which various embodiments may be implemented.

FIG. 2 depicts a flow chart diagram for a process to enhance user input to a conversational agent with agent feedback according to an embodiment.

FIG. 3 depicts a cloud computing environment according to an embodiment.

FIG. 4 depicts abstraction model layers according to an embodiment.

### DETAILED DESCRIPTION

The performance and effectiveness of a chatbot may depend on the natural language comprehension by and of which the chatbot may determine, such as through a natural language classifier, variously expressed intents. Higher and more granular levels of understanding and interpretation may allow for more accurate determinations to be made, enabling better performance by the chatbot in meaningfully communicating with end-users.

For example, user inputs from end-users including requests, phrases, or questions such as “I want to change the password of my system,” “I forgot the password of my system, can you send it to me?”, and “I lost the password. How can I recover it?” express similar but distinct intents having slightly varying requirements. A limited understanding or a coarse interpretation of the expressed intents may reduce the usefulness and utility of a chatbot, causing the chatbot to determine each of the intents as relating only to “password,” thereby reducing the chatbot's ability to support and facilitate natural language communications with end-users. As such, outputs produced by the chatbot with respect to the user inputs may be less meaningful, helpful, and desirable, and may only be partially relevant with respect to compatibly expressed intents. An increase in the limits of understanding, or a fine-tuning of interpretation, of the expressed intents may increase the usefulness and utility of a chatbot, enabling the chatbot to determine each of the intents as relating to “password_change,” “password_email_recovery,” and/or “password_recovery,” respectively, thereby increasing the chatbot's ability to support and facilitate natural language communications with end-users. As such, outputs produced by the chatbot with respect to the user inputs may be more meaningful, helpful, and desirable, and may be sufficiently relevant to variously expressed intents.

Equally important to the need for increasing the granularity of a chatbot's understanding of a user's intent of the end-user may be the need to enhance the usefulness of queries. Many users may face a challenge when interacting with conversational agents such as chatbots or digital assistants when the users do not know how to properly phrase a question or query such that the chatbot fails to understand the input and this may often lead to inaccurate answers or no answer at all from the chatbot. For example, a user may not know the names of various elements or content of a webpage, application, or service. A user may also use a colloquial name for an entity that the chatbot cannot recognize. In these instances, a user may waste time getting erroneous answers simply because their question or query was not worded properly for the conversational agent to provide an adequate answer.

Therefore, it may be advantageous for a chatbot to provide prompts or feedback to a user to change the words of a question or query such that the chatbot may properly recognize the user's intent within the boundaries of the intents that the chatbot has been trained to recognize, such that the chatbot may provide a relevant answer. The words that a user may type into a chatbot application may be reviewed for similarity against a list of words that the chatbot may recognize as related to one of the classified intents, so-called “keywords”, that are within a corpus of knowledge of the chatbot. As words may be typed, if they are a match to an intent, then they may be displayed on the screen in a distinct typeface such that the user may know that the word was understood. Because of the conversational nature of chatbots, there may also be words that are not directly related to the query but assist in forming complete sentences, such as articles or descriptive adjectives or active verbs. These words may be ignored by the method or else identified as having been understood but since they do not relate to the intent, no further analysis would be necessary. Any words that may not match any of the keywords that a chatbot recognizes for one of its intents may then be analyzed for similarity to keywords and the word as typed may be presented to the user in a separate distinct typeface. This may allow the user to click on the word and be presented with the list of keywords for the classified intent such that the user may select a similar keyword to replace the original word. Such a method may improve the technical ability of a chatbot to answer and also improve the user experience because of the increase in likelihood that the user may receive a useful answer to a question.

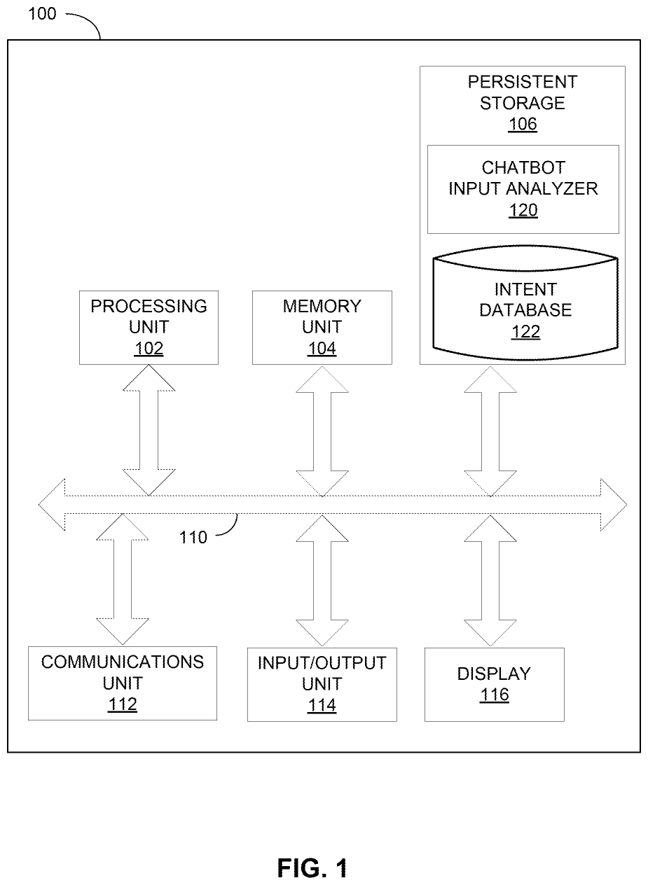

Referring now to FIG. 1, there is shown a block diagram illustrating a computer system 100 in accordance with an embodiment. It should be appreciated that FIG. 1 provides only an illustration of one implementation and does not imply any limitations with regard to the environments in which different embodiments may be implemented. Many modifications to the depicted environments may be made based on design and implementation requirements. For example, computer system 100 may be implemented in hardware only, software only, or a combination of both hardware and software. Computer system 100 may have more or fewer components and modules than shown, may combine two or more of the components, or may have a different configuration or arrangement of the components. Computer system 100 may include any additional component enabling it to function as an operable computer system, such as a motherboard, data busses, power supply, a network interface card, a display, an input device (e.g., keyboard, pointing device, touch-sensitive display), etc. (not shown). Moreover, components of computer system 100 may be co-located or distributed, or the system could run as one or more cloud computing “instances,” “containers,” and/or “virtual machines,” as known in the art.

As shown, a computer system 100 includes a processor unit 102, a memory unit 104, a persistent storage 106, a communications unit 112, an input/output unit 114, a display 116, and a system bus 110. Computer programs such as chatbot input analyzer 120 may be stored in the persistent storage 106 until they are needed for execution, at which time the programs are brought into the memory unit 104 so that they can be directly accessed by the processor unit 102. The processor unit 102 selects a part of memory unit 104 to read and/or write by using an address that the processor unit 102 gives to memory unit 104 along with a request to read and/or write. Usually, the reading and interpretation of an encoded instruction at an address causes the processor unit 102 to fetch a subsequent instruction, either at a subsequent address or some other address. The processor unit 102, memory unit 104, persistent storage 106, communications unit 112, input/output unit 114, and display 116 all interface with each other through the system bus 110.

Examples of computing systems, environments, and/or configurations that may be represented by the computer system 100 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

Each computing system 100 may also include a communications unit 112 such as TCP/IP adapter cards, wireless Wi-Fi interface cards, or 3G or 4G wireless interface cards or other wired or wireless communication links. Communication between mobile devices may be accomplished via a network and respective network adapters or communication units 112. In such an instance, the communication network may be any type of network configured to provide for data or any other type of electronic communication. For example, the network may include a local area network (LAN), a wide area network (WAN), a virtual private network (VPN), a mobile or cellular telephone network, the Internet, or any other electronic communication system. The network may use a communication protocol, such as the transmission control protocol (TCP), the user datagram protocol (UDP), the internet protocol (IP), the real-time transport protocol (RTP) the Hyper Text Transport Protocol (HTTP), or a combination thereof.

The computer system 100 may be used for processing user input to a conversational agent such as a chatbot that may employ a supervised machine learning classification model to determine an intent of the input from the user. For example, a user may attempt to get details about a specific product from an automated agent on the website of a retail store by typing a question into a text box on the computer screen. In this scenario, the chatbot analyzer 120 may analyze the words that may be typed into a window on the website, e.g., a chat window, and display the words as they are typed, along with changing the typeface or font to indicate whether or not the word may be understood and/or whether alternative words should be substituted for what may be typed by a user.

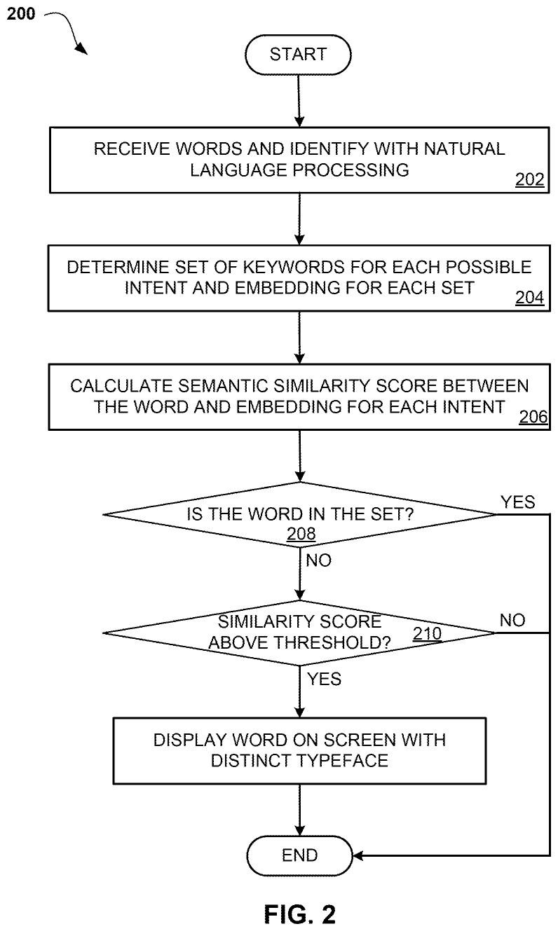

Referring to FIG. 2, an operational flowchart illustrating a process 200 for enhancing user input to a conversational agent with agent feedback is depicted according to at least one embodiment. At 202, a word may be received from a user as part of a query or any attempt to obtain knowledge from the conversational agent. One of ordinary skill in the art may recognize that a query may be in the form of typed words, such as the “chat” function on a website, or may be a spoken query, in which case a microphone that may be embedded in the computer or in a mobile device connected to the user or simply in proximity to the user and/or the computer may be used to capture the spoken query and a speech-to-text algorithm may be used to convert the spoken words into text that may be processed in the same way as if they were typed directly into the computer by the user. The word may be identified at this step and a meaning of the word determined using a natural language processing algorithm. It should also be noted that, while each word may be identified and process at the time that the user enters the word, any words that may be subsequently entered may change the meaning of what is entered. For instance, if a user enters “password”, as described above, one set of keywords may be used based on the intent of that word. However, if a user continues and enters “recovery” next, this may necessitate an entirely different set of keywords. The words may be combined into a phrase and the analysis may be done for the phrase instead of the separate words, including the determination of a word embedding and the calculation of a semantic similarity score. It is not required that a predefined number of words are analyzed as each word may be analyzed in the context of words that have already been entered by the user.

It is important to note that any monitoring and collection of data from a conversational agent as mentioned herein requires the informed consent of all those people whose data is captured for analysis. Consent may be obtained in real time or through a prior waiver or other process that informs a subject that their data may be captured by appropriate devices or other sensitive personal data may be gathered through any means and that this data may be analyzed by any of the many algorithms that may be implemented herein. A user may opt out of any portion of the conversational agent monitoring at any time.

At 204, a set of keywords that may be identified as related to a specific cognitive intent of a user may be generated. The conversational agent may have a set of cognitive intents within a database, e.g., intent database 122, connected to the agent. For instance, a retail store website may have a set of topics that relate to its products, such as pricing or product type or a task that may be completed by a user in conjunction with one of the products sold by the retail store. For each of these intents stored within intent database 122, a set of keywords may be identified as being related to the intent. As an example, the intent in the database may be “purchasing a television” and keywords related to the intent may be certain features of television, including “high-definition” or “OLED” or “plasma”. These keywords identified in the process may be gathered into a list and associated with the intent such that, if it is determined later in the process that the user's intent is related to “television”, then the list generated at this step may be compared to a word that may be entered by the user and displayed to the user if the entered word does not match the meaning of words related to the intent and a user desires to see potential alternatives.

In determining the keywords to include in the set, a word embedding may be defined for each of the keywords. One of ordinary skill in the art may recognize that in natural language processing algorithms, word embedding is a term used for the representation of words for text analysis, typically in the form of a real-valued vector that encodes the meaning of the word such that the words that are closer in the vector space are expected to be similar in meaning. Word embeddings may be obtained using a set of language modeling and feature learning techniques where words or phrases from the vocabulary are mapped to vectors of real numbers. Conceptually this method may involve the mathematical embedding from space with many dimensions per word to a continuous vector space with a much lower dimension. Some examples of methods to generate this mapping may include neural networks, dimensionality reduction on the word co-occurrence matrix, probabilistic models, explainable knowledge base method, and explicit representation in terms of the context in which words appear.

The word embeddings for the keyword in a set may then be combined into an overall embedding for the set, which may allow for the word to be compared to the entire set of keywords more efficiently and quickly narrow a search from the entire knowledge base of the agent to specific sets of keywords and, in turn, possible intents that may be known by the agent.

At 206, a semantic similarity score may be calculated for each cognitive intent stored in the database and relating to the conversational agent. The score may be a measure of similarity of meaning between the word and the set of keywords, with the intention of determining the intent of the user in using the word in the query. If the word does not directly appear in the set and the semantic similarity score is high enough, the chatbot analyzer 120 may suggest possible alternative words from the set that may be substituted for the original word and provide that feedback to the user, in the form of a different typeface or font, as mentioned above, at which point a user may indicate an inclination to view the alternative words.

Semantic similarity, or Semantic Textual Similarity, is a concept within natural language processing that may measure the relationship between texts or documents using a defined metric such as a score. Semantic similarity may be defined over a set of documents or terms, where the idea of a semantic distance between items may be based on the likeness of word meaning or semantic content as opposed to lexicographical similarity. These are mathematical tools used to estimate the strength of the semantic relationship between units of language, concepts or instances, through a numerical description obtained according to the comparison of information supporting their meaning or describing their nature.

Computationally, semantic similarity can be estimated by defining a topological similarity, by using ontologies to define the distance between terms or concepts. The effectiveness of semantic similarity score calculations may be evaluated based on the use of datasets designed by experts and composed of word pairs with semantic similarity degree estimation and also based on the integration of the measures inside specific applications such the information retrieval, recommender systems, or natural language processing systems such as that used in the chatbot analyzer 120. Higher semantic similarity scores may indicate a higher level of similarity between the two objects of the calculation, in this case the word that has been entered by a user and the overall word embedding calculated in 204 for the set of keywords corresponding to a specific cognitive intent within the database connected to the conversational agent.

At 208, the entered word may be compared to the keywords in all of the sets that were determined in 204 and if a match is found in one of the sets of keywords, the entered word may be displayed to the user on the screen with an indication, such as a distinct typeface, that the word may be recognized along with a connection to one of the intents that may be stored within the database connected to the agent. Since there is no ambiguity in this situation and no need to make any changes to the entered word, no further processing may be needed by the method.

Similarly, because the agent may engage with a human that may use a conversational format in framing a query, there may be additional words entered that, in certain contexts, do not add to the intent determination or provide any information to the conversational agent, such as articles, e.g., “a” or “the”, or conjunctive words such as “or” and also certain adjectives or adverbs that may not pertain to the subject of the query. Such words may be treated in the same manner as words that may be found in a set of keywords and displayed to the user in the same way as the words that may be found in a set. At that point, no further processing of the word may be needed by the method. It should be noted here that context may be considered when making this determination as a word such as “with” or “in” may be used to describe features of a product or a specific function that may be critical to the user's intent in engaging the agent. Because the goal of the method is to provide feedback for improving the input to the agent, words may fall into different categories as described herein depending on the entire query.

At 210, if no direct match is found in any set of keywords, then the semantic similarity score calculated at 206 may determine how the word may be processed. First, the score may be compared to a predefined threshold that may be set to ensure a minimum level of similarity between the entered word and any suggested alternative. This threshold may also indicate a level of confidence by the method in the alternative words that it may suggest to a user. Once above the threshold, the set of keywords corresponding to an embedding having the highest calculated semantic similarity score with respect to the entered word may be used as potential alternative suggestions to the user. This condition may be indicated to the user at 212 by displaying the entered word within the chat window and using a separate distinct typeface, such as italics, to indicate to the user that the word has not been recognized as being related to the determined intent of the query. At this point, the user may click on the entered word and the set of keywords corresponding to the highest semantic similarity score may be displayed to the user as long as the score is above the threshold. If no similarity scores are above the threshold, then the entered word may still be displayed to the user as not recognized by the agent, but no alternatives would be displayed to the user as the agent may not be clear as to the intent of the user. At this point, no further processing of the entered word may be required.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

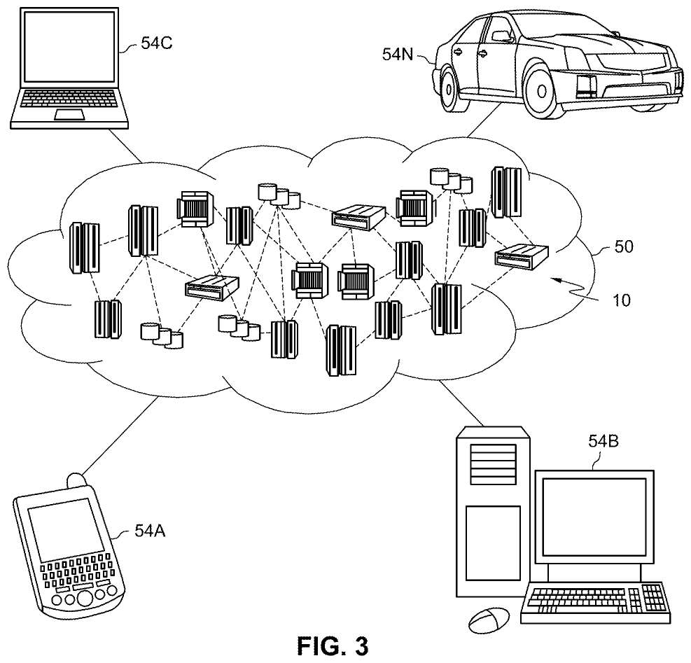

Referring now to FIG. 3, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection (e.g., using a web browser).

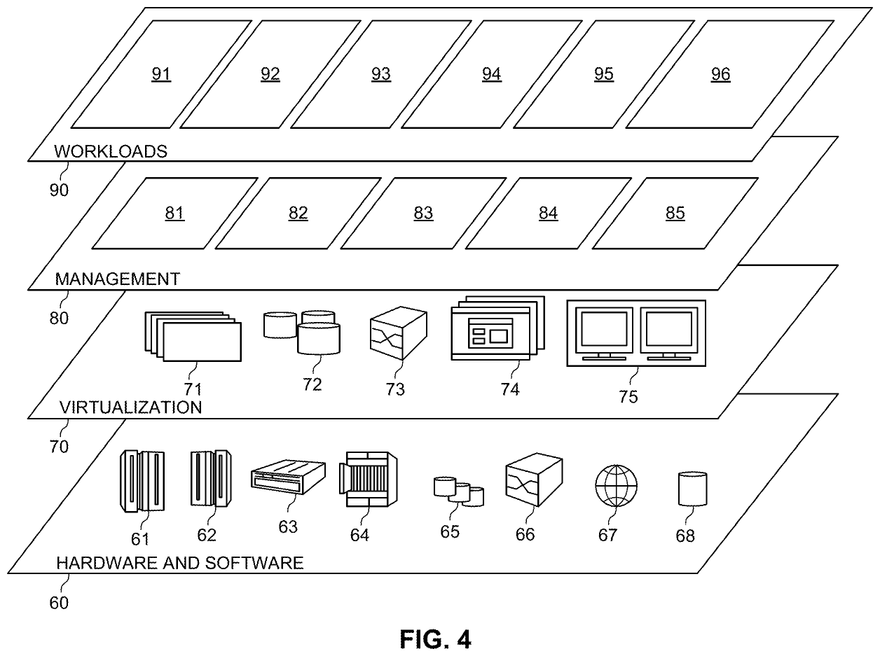

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66, such as a load balancer. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include mapping and navigation 91; software development and lifecycle management 92; virtual classroom education delivery 93; data analytics processing 94; transaction processing 95; and chatbot analyzer 96. Chatbot analyzer 96 may refer to a method for enhancing user input to a conversational agent with feedback.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for enhancing user input to a conversational agent comprised of:
identifying a word using a natural language processing algorithm, wherein the word is in a query from a user to the conversational agent;
determining a set of keywords related to each of a plurality of intents associated with the conversational agent within a database;
calculating a semantic similarity score between each determined set of keywords and the identified word; and
displaying the identified word on a screen to the user when the identified word is not found in each determined set of keywords and when the semantic similarity score is above a threshold, wherein the display includes a distinct indication of the identified word.

2. The computer-implemented method of claim 1, further comprising:
in response to an indication from the user, displaying to the user a list of keywords from the determined set of keywords corresponding to an intent with a highest semantic similarity score; and
in response to the user selecting a keyword from the displayed list, replacing the identified word on the screen with the selected keyword.

3. The computer-implemented method of claim 1, wherein identifying the word further comprises:
determining a meaning of the word with the natural language processing algorithm;
generating a synonym, wherein the synonym has a meaning that matches the meaning of the word;
calculating a new semantic similarity score between each determined set of keywords and the synonym; and
displaying the identified word on the screen to the user when the synonym is not found in each determined set of keywords and when the semantic similarity score is above the threshold, wherein the display includes the distinct indication of the identified word.

4. The computer-implemented method of claim 1, further comprising:
receiving a second word from the user, wherein the second word is included in the query and is entered at a time subsequent to the identified word;
combining the second word and the identified word into a phrase and identifying the phrase using the natural language processing algorithm;
generating a combined semantic similarity score between each determined set of keywords and the phrase;
displaying the phrase on the screen to the user when the phrase is not found in each determined set of keywords and when the combined semantic similarity score is above the threshold, wherein the display includes the distinct indication of the identified word.

5. The computer-implemented method of claim 1, wherein determining the set of keywords further comprises:
calculating a word embedding for each keyword in the set of keywords;
combining the calculated word embeddings for each keyword in the set of keywords into an overall embedding for the set; and
storing the overall embedding for the set with the set of keywords in the database.

6. The computer-implemented method of claim 1, further comprising:
capturing a spoken query from the user using a microphone; and
generating the word using a speech-to-text algorithm.

7. The computer-implemented method of claim 1, wherein the distinct indication of the identified word includes a distinct typeface or a distinct font.

8. A computer system for enhancing user input to a conversational agent comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
identifying a word using a natural language processing algorithm, wherein the word is in a query from a user to the conversational agent;
determining a set of keywords related to each of a plurality of intents associated with the conversational agent within a database;
calculating a semantic similarity score between each determined set of keywords and the identified word; and
displaying the identified word on a screen to the user when the identified word is not found in each determined set of keywords and when the semantic similarity score is above a threshold, wherein the display includes a distinct indication of the identified word.

9. The computer system of claim 8, further comprising:
in response to an indication from the user, displaying to the user a list of keywords from the determined set of keywords corresponding to an intent with a highest semantic similarity score; and
in response to the user selecting a keyword from the displayed list, replacing the identified word on the screen with the selected keyword.

10. The computer system of claim 8, wherein identifying the word further comprises:
determining a meaning of the word with the natural language processing algorithm;
generating a synonym, wherein the synonym has a meaning that matches the meaning of the word;
calculating a new semantic similarity score between each determined set of keywords and the synonym; and
displaying the identified word on the screen to the user when the synonym is not found in each determined set of keywords and when the semantic similarity score is above the threshold, wherein the display includes the distinct indication of the identified word.

11. The computer system of claim 8, further comprising:
receiving a second word from the user, wherein the second word is included in the query and is entered at a time subsequent to the identified word;
combining the second word and the identified word into a phrase and identifying the phrase using the natural language processing algorithm;
generating a combined semantic similarity score between each determined set of keywords and the phrase;
displaying the phrase on the screen to the user when the phrase is not found in each determined set of keywords and when the combined semantic similarity score is above the threshold, wherein the display includes the distinct indication of the identified word.

12. The computer system of claim 8, wherein determining the set of keywords further comprises:
calculating a word embedding for each keyword in the set of keywords;
combining the calculated word embeddings for each keyword in the set of keywords into an overall embedding for the set; and
storing the overall embedding for the set with the set of keywords in the database.

13. The computer system of claim 8, further comprising:
capturing a spoken query from the user using a microphone; and
generating the word using a speech-to-text algorithm.

14. The computer system of claim 8, wherein the distinct indication of the identified word includes a distinct typeface or a distinct font.

15. A computer program product for enhancing user input to a conversational agent comprising:
a computer readable storage device having program instructions embodied therewith, the program instructions executable by a processor to cause the processor to perform a method comprising:
identifying a word using a natural language processing algorithm, wherein the word is in a query from a user to the conversational agent;
determining a set of keywords related to each of a plurality of intents associated with the conversational agent within a database;
calculating a semantic similarity score between each determined set of keywords and the identified word; and
displaying the identified word on a screen to the user when the identified word is not found in each determined set of keywords and when the semantic similarity score is above a threshold, wherein the display includes a distinct indication of the identified word.

16. The computer program product of claim 15, further comprising:
in response to an indication from the user, displaying to the user a list of keywords from the determined set of keywords corresponding to an intent with a highest semantic similarity score; and
in response to the user selecting a keyword from the displayed list, replacing the identified word on the screen with the selected keyword.

17. The computer program product of claim 15, wherein identifying the word further comprises:
determining a meaning of the word with the natural language processing algorithm;
generating a synonym, wherein the synonym has a meaning that matches the meaning of the word;
calculating a new semantic similarity score between each determined set of keywords and the synonym; and
displaying the identified word on the screen to the user when the synonym is not found in each determined set of keywords and when the semantic similarity score is above the threshold, wherein the display includes the distinct indication of the identified word.

18. The computer program product of claim 15, further comprising:
receiving a second word from the user, wherein the second word is included in the query and is entered at a time subsequent to the identified word;
combining the second word and the identified word into a phrase and identifying the phrase using the natural language processing algorithm;
generating a combined semantic similarity score between each determined set of keywords and the phrase;
displaying the phrase on the screen to the user when the phrase is not found in each determined set of keywords and when the combined semantic similarity score is above the threshold, wherein the display includes the distinct indication of the identified word.

19. The computer program product of claim 15, wherein determining the set of keywords further comprises:
calculating a word embedding for each keyword in the set of keywords;
combining the calculated word embeddings for each keyword in the set of keywords into an overall embedding for the set; and
storing the overall embedding for the set with the set of keywords in the database.

20. The computer program product of claim 15, further comprising:
capturing a spoken query from the user using a microphone; and
generating the word using a speech-to-text algorithm.
